(19) United States
(12) Patent Application Publication
(10) Pub. No.: US 2023/0400839 A1
(43) Pub. Date: Dec. 14, 2023

(54) FDC SYSTEM WITH WORKFLOW CONNECTED BY MODULARIZING ENTIRE PROCESS AND PROCESSING METHOD THEREOF

(71) Applicant: MISOINFO Tech., Seoul (KR)

(72) Inventors: Dong Uk An, Seoul (KR); Sang-do Nam, Seoul (KR); Jin-ho Son, Hanam-si (KR); Dong-hyun Seo, Goyang-si (KR)

(21) Appl. No.: 17/972,506

(22) Filed: Oct. 24, 2022

(30) Foreign Application Priority Data
May 20, 2022 (KR) 10-2022-0061958

(51) Int. Cl. G05B 19/418; G06N 20/00

(52) U.S. Cl. CPC G05B 19/41865; G06N 20/00

(57) ABSTRACT

One aspect of the present disclosure relates to a fault detection & classification (FDC) system, which is a system for managing a process of manufacturing a semiconductor or the like, and more particularly, to an FDC system with a workflow connected by modularizing an entire process, in which processes such as preprocessing, learning, and prediction are modularized so as to be managed, and modules are connected to each other to generate the workflow so that application to different projects is facilitated, and the entire process is managed more systematically.

### CROSS REFERENCE TO RELATED APPLICATION

The present application claims priority to Korean Patent Application No. 10-2022-0061958, filed on May 20, 2022, the entire contents of which is incorporated herein for all purposes by this reference.

### BACKGROUND OF THE INVENTION

### 1. Field of the Invention

One aspect of the present disclosure relates to a fault detection & classification (FDC) system, which is a system for managing a process of manufacturing a semiconductor or the like, and a processing method thereof, and more particularly, to an FDC system with a workflow connected by modularizing an entire process and a processing method thereof, in which processes such as preprocessing, learning, and prediction are modularized so as to be managed, and modules are connected to each other to generate the workflow so that application to different projects is facilitated, and the entire process is managed more systematically.

### 2. Description of the Related Art

Manufacturing facilities for manufacturing industries such as semiconductors and LCDs require great investment costs. In particular, a significant part of the cost may correspond to a device cost. Accordingly, manufacturing companies that produce products by using advanced facilities have been making efforts to thoroughly manage facilities.

Among schemes for managing manufacturing facilities, there is a technique of detecting a malfunction by monitoring data on process conditions such as a temperature, a pressure, and a time. Sensors for measuring the data on the process conditions according to a time variation may be installed in a process system. A user or the like may recognize a variation in a value for the process condition according to the time variation based on data measured through the sensor. Accordingly, the user or the like may recognize a current device state.

However, since values for the process conditions are generally generated consecutively in a unit of a second, and dozens or hundreds of process conditions or more exist in one process system, an amount of the data on the process conditions may become massive. Therefore, there is a need for a technique that allows a user to conveniently view accurate data by analyzing and displaying a large amount of data on process conditions by using a statistical scheme. The technique belongs to a fault detection and classification (FDC) field.

Since a yield (or final inspection) measurement result, which represents a ratio of a finished fair product to a number of inputs, indicates a fair/defective state and a quality state when all processes have been completed, the yield (or final inspection) measurement result is very important. A highest objective and a key point of production activities may be to maximize a yield and to maintain highest quality.

In particular, installation or maintenance has been performed on all devices used in processes to maintain a best state for each process and to increase productivity. Facility maintenance means maintenance and repair of a facility, and to put it simply, the facility maintenance refers to an operation of repairing a device upon a failure of the device and performing maintenance (e.g., greasing) to ensure normal performance.

Facility preservation for a device refers to an operation of maintaining an entire production system or any specific facility in an operable state. The preservation may allow a device state to become better than a device state before the preservation, and may also bring a change to an existing device state so as to cause a variation in an existing trend.

Even without an influence of the device preservation, the device state may exhibit a variation in a trend due to a variation over a time (aging) such as contamination and deposition according to progress of the process. Therefore, in a long term, FDC data may exhibit a variation in a trend due to a variation over a time of the device, a variation caused by the preservation, and the like.

However, according to the related art, preprocessing, learning, and prediction processes have been intertwined, so that there have been difficulties in application to different projects and systematic management of an entire process. Therefore, a need for an FDC system in which application to different projects is facilitated, and an entire process is managed more systematically has emerged.

### DOCUMENTS OF RELATED ART

### Patent Documents

Korean Patent Registration No. 10-0734531 (published on Jul. 4, 2007), “Method for Requesting Trace Data Reports from FDC Semiconductor Fabrication Process and Semiconductor Fabrication Processing System”

### SUMMARY OF THE INVENTION

To solve the problems described above, an object of one aspect of the present disclosure is to provide an FDC system with a workflow connected by modularizing an entire process and a processing method thereof, in which processes such as preprocessing, learning, and prediction may be modularized so as to be managed, and modules may be connected to each other to generate the workflow so that application to different projects may be facilitated, and the entire process may be managed more systematically.

To achieve the object described above, according to one aspect of the present disclosure, there is provided an FDC system with a workflow connected by modularizing an entire process, wherein the FDC system includes the workflow in which a preprocessing module, a learning module, and a prediction module are connected to each other.

In addition, the learning module may include a learning module-file reader, a learning module-runner, a learning module-controller, a learning module-operator, and a learning module-file writer, and the prediction module may include a prediction module-file reader, a prediction module-runner, a prediction module-controller, a prediction module-operator, and a prediction module-file writer.

In addition, according to one aspect of the present disclosure, there is provided a method of processing an FDC system with a workflow connected by modularizing an entire process, the method including: a preprocessing module driving step (S10) of performing preprocessing on data incoming in real time by using a preprocessing module; a learning module driving step (S20) of generating a learning model by performing learning on the data, which has been subject to the preprocessing in the preprocessing module driving step (S10), by using a learning module; and a prediction module driving step (S30) of performing prediction by using a prediction module based on the learning model in the learning module driving step (S20).

In addition, the learning module driving step (S20) may include a learning module-file reading step (S21), a learning module-planning step (S22), a learning module-data length equalization step (S23), a learning module-data normalization step (S24), a learning module-training step (S25), and a learning module-file writing step (S26).

In addition, the prediction module driving step (S30) may include a prediction module-file reading step (S31), a prediction module-planning step (S32), a prediction module-prediction progress step (S33), a prediction module-evaluation progress step (S34), and a prediction module-file writing step (S35).

According to the FDC system with the workflow connected by modularizing the entire process and the processing method thereof of one aspect of the present disclosure, processes such as preprocessing, learning, and prediction may be modularized so as to be managed, and modules may be connected to each other to generate the workflow so that application to different projects can be facilitated, and the entire process can be managed more systematically.

### BRIEF DESCRIPTION OF THE DRAWINGS

FIG. 1 is a view illustrating a workflow of an FDC system with a workflow connected by modularizing an entire process according to one aspect of the present disclosure.

FIG. 2 is a view illustrating a preprocessing module of the FDC system with the workflow connected by modularizing the entire process according to one aspect of the present disclosure.

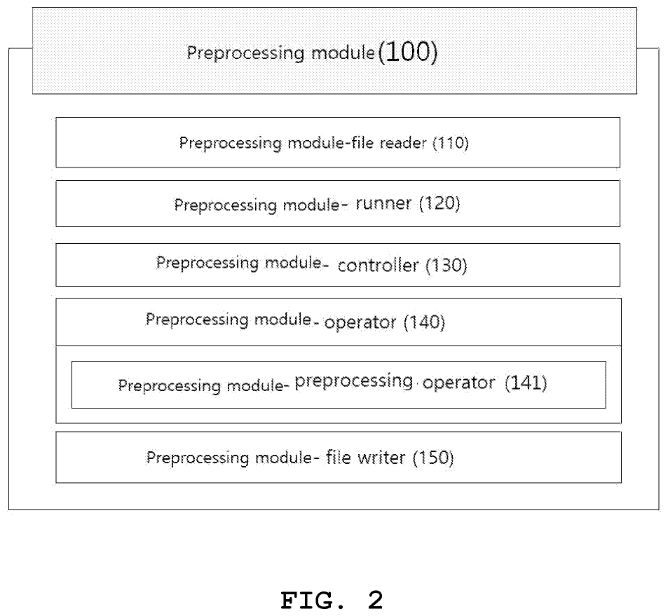

FIG. 3 is a view illustrating a learning module of the FDC system with the workflow connected by modularizing the entire process according to one aspect of the present disclosure.

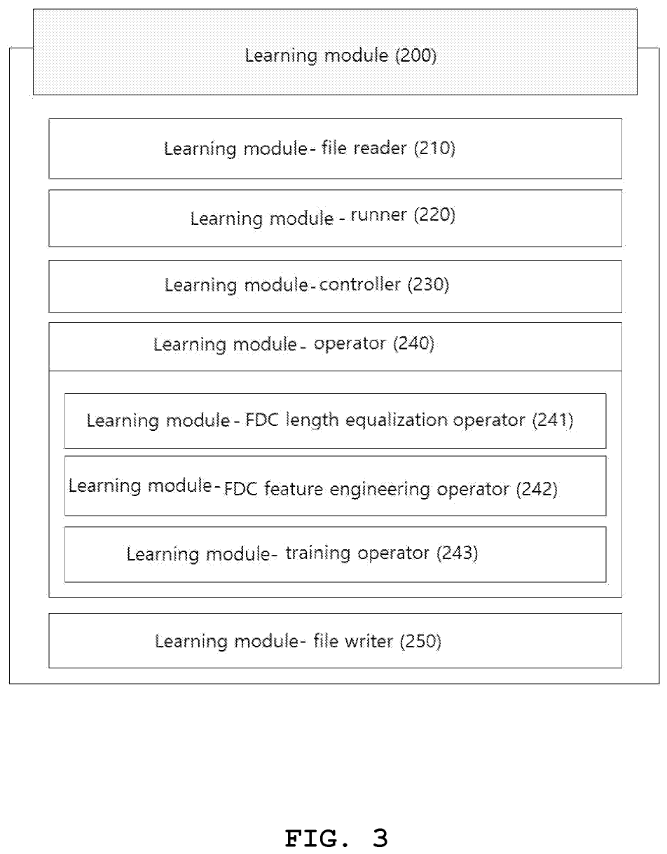

FIG. 4 is a view illustrating a prediction module of the FDC system with the workflow connected by modularizing the entire process according to one aspect of the present disclosure.

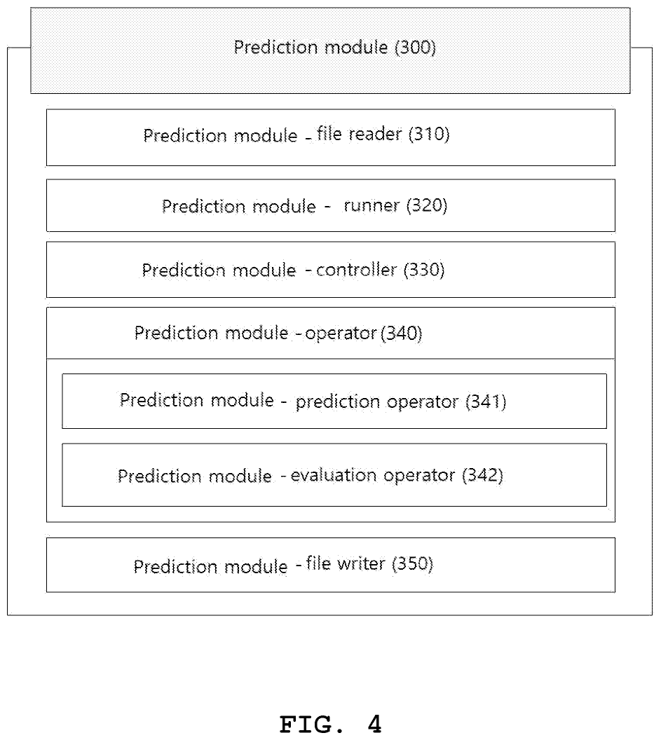

FIG. 5 is a flowchart showing an overall process of a method of processing an FDC system with a workflow connected by modularizing an entire process according to one aspect of the present disclosure.

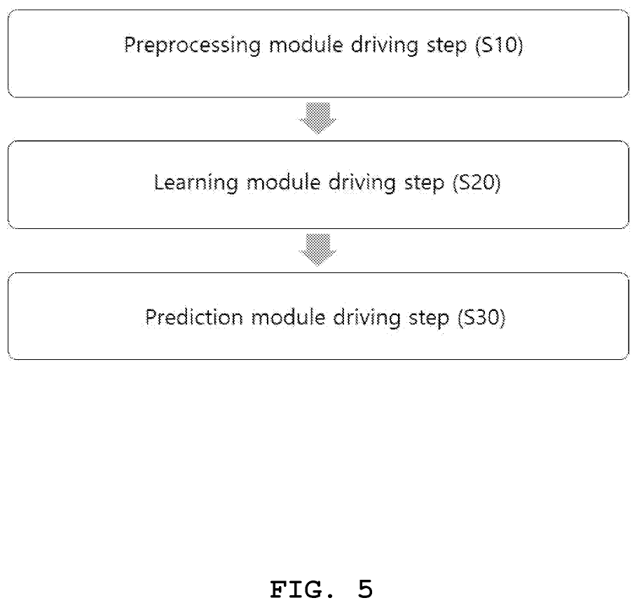

FIG. 6 is a flowchart showing a detailed process of a preprocessing module driving step S10 of the method of processing the FDC system with the workflow connected by modularizing the entire process according to one aspect of the present disclosure.

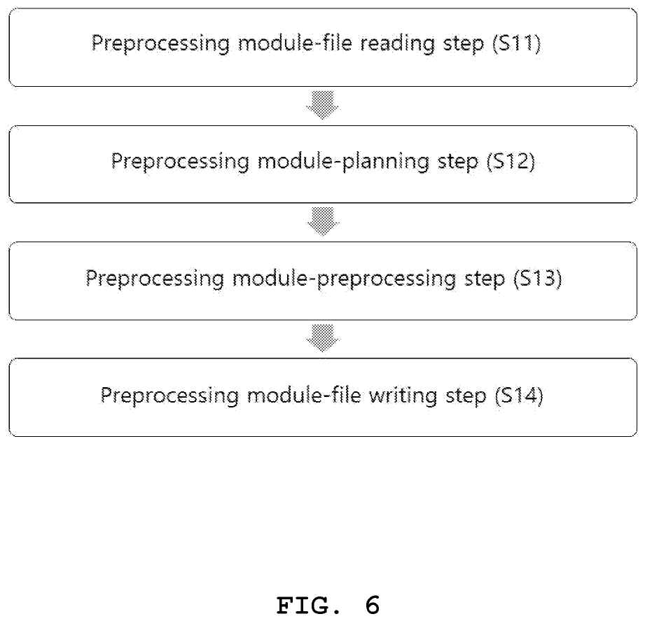

FIG. 7 is a flowchart showing a detailed process of a learning module driving step S20 of the method of processing the FDC system with the workflow connected by modularizing the entire process according to one aspect of the present disclosure.

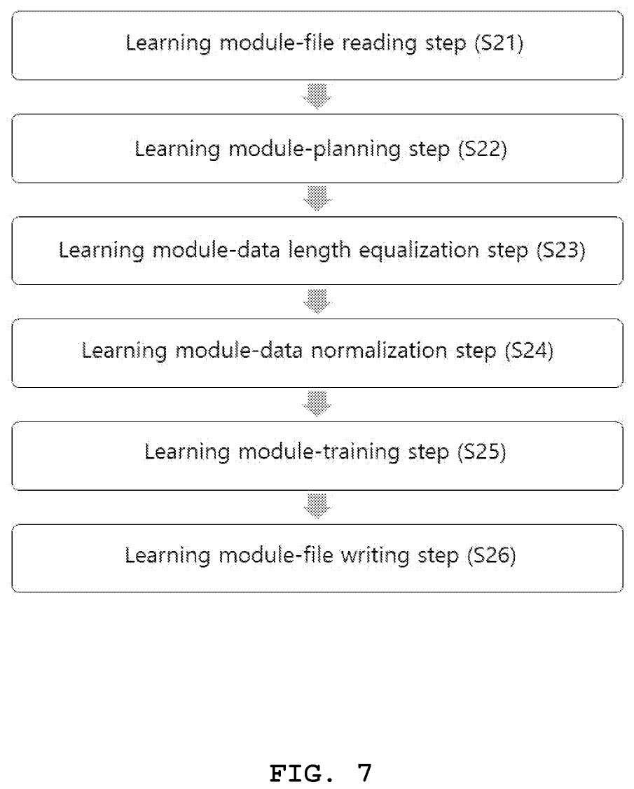

FIG. 8 is a flowchart showing a detailed process of a prediction module driving step S30 of the method of processing the FDC system with the workflow connected by modularizing the entire process according to one aspect of the present disclosure.

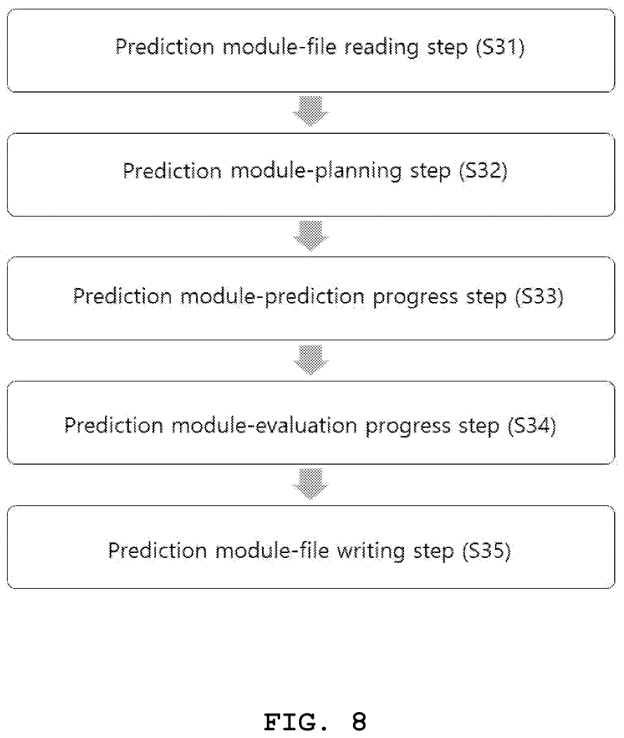

### DETAILED DESCRIPTION OF THE INVENTION

The following detailed descriptions of the present disclosure are given for embodiments in which the present disclosure may be practiced, and refer to the accompanying drawings that illustrate the embodiments. These embodiments are described in sufficient detail to enable those skilled in the art to practice the present disclosure. It is to be understood that various embodiments of the present disclosure are different from each other, but need not be mutually exclusive. For example, specific shapes, structures, and characteristics described herein may be implemented and changed from one embodiment to another embodiment without departing from the idea and scope of the present disclosure. In addition, it is to be understood that positions or arrangements of individual elements in each embodiment described herein may vary without departing from the idea and scope of the present disclosure.

Therefore, the following detailed description is not to be taken in a limiting sense, and the scope of the present disclosure is defined only by the appended claims while encompassing the scope of all equivalents of the claimed disclosure when appropriately described. In the drawings, like reference numerals refer to elements that perform the same or similar functions in various aspects.

Regarding the terms used herein, general terms that are currently used as widely as possible are selected in consideration of functions thereof in the present disclosure.

However, the meanings of the terms may vary according to the intention of those skilled in the art, judicial precedents, the emergence of new technologies, and the like. In addition, in certain cases, a term may be selected at discretion of the applicant. In this case, the meaning of the term will be described in detail at a corresponding part in the description of the invention. Therefore, the terms used herein are to be defined based on the meanings of the terms and the contents throughout the present disclosure without being simply limited to names of the terms.

In the present disclosure, when some part “includes” some elements, unless explicitly described to the contrary, it means that other elements may be further included but not excluded.

Hereinafter, an FDC system with a workflow connected by modularizing an entire process according to one aspect of the present disclosure will be described in detail.

According to one aspect of the present disclosure, the FDC system with the workflow connected by modularizing the entire process may include the workflow W in which a preprocessing module 100, a learning module 200, and a prediction module 300 are connected to each other.

The workflow W may have a configuration including a plurality of modules n00. The workflow W may represent a movement of information or a task through a work procedure, and may also be referred to as a work flow. In more detail, the workflow according to one aspect of the present disclosure may be a configuration in an operational aspect of the work procedure. According to one aspect of the present disclosure, the workflow W may include a plurality of modules n00, which interwork with each other.

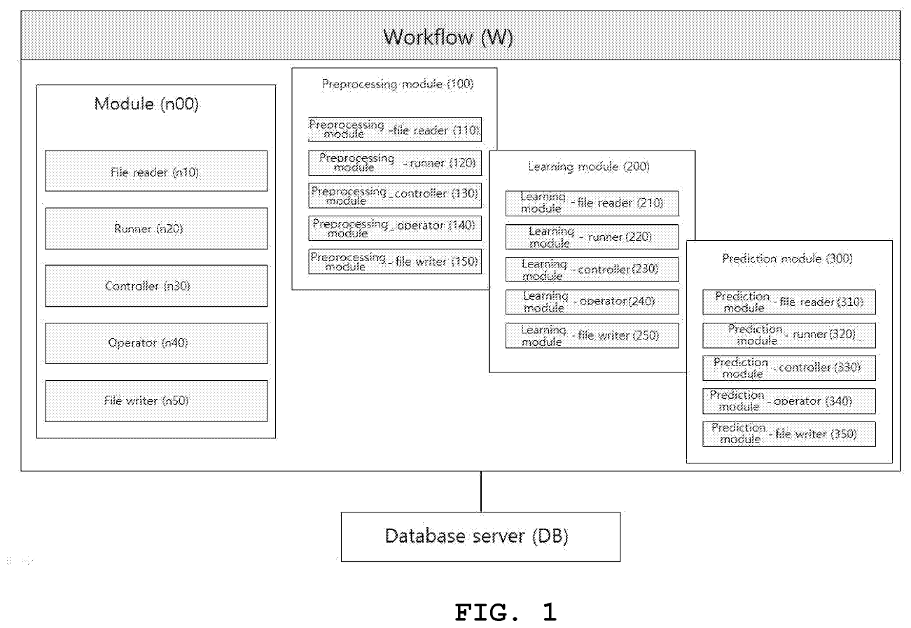

As shown in FIG. 1, the workflow W may include the modules n00. Each of the modules n00 may include a file reader n10, a runner n20, a controller n30, an operator n40, and a file writer n50. The workflow W may be preferably connected to a database server DB.

The file reader n10 may serve to read data by interworking with the database server DB. In this case, the data read by the file reader n10 may be monitoring-related data for a work process of an actual manufacturing site, and may be data received in real time. Alternatively, the data may be data obtained by conversion through a process in each of the modules n00 that are different from each other. The file reader n10 may utilize Apache Kafka. The ‘Apache Kafka’ may be one of systems considered when establishing a data pipeline, and may be a distributed messaging system that is first developed by LinkedIn. The ‘Apache Kafka’ has been recognized as an essential tool for connecting data to a plurality of storage analysis systems when big data is analyzed.

The runner n20 may serve to execute a separate process according to each of the modules n00. In this case, the runner n20 may function to determine a role of the module n00. A property of determining whether a specific module n00 is to perform a preprocessing function, a learning function, or a prediction function may be determined according to a preset runner n20.

The controller n30 may serve to perform data flow planning and control of each of the modules n00. In this case, the controller n30 may perform data flow planning and control differently according to each of the modules n00.

The operator n40 may be a fundamental configuration that processes data in each of the modules n00. In this case, the operator n40 may include a plurality of detailed sub-operators according to each of the modules n00.

The file writer n50 may perform a write function on the data that has been processed in each of the modules n00 by interworking with the database server DB. In other words, the file writer n50 may serve to store the data processed and output from each of the modules n00. The file writer n50 may utilize Apache Kafka. The ‘Apache Kafka’ may be one of systems considered when establishing a data pipeline, and may be a distributed messaging system that is first developed by LinkedIn. The ‘Apache Kafka’ has been recognized as an essential tool for connecting data to a plurality of storage analysis systems when big data is analyzed.

The workflow W may include a preprocessing module 100, a learning module 200, and a prediction module 300.

Each of the preprocessing module 100, the learning module 200, and the prediction module 300 may include a file reader n10, a runner n20, a controller n30, an operator n40, and a file writer n50.

For example, the preprocessing module 100 may include a preprocessing module-file reader 110, a preprocessing module-runner 120, a preprocessing module-controller 130, a preprocessing module-operator 140, and a preprocessing module-file writer 150.

In addition, the learning module 200 may include a learning module-file reader 210, a learning module-runner 220, a learning module-controller 230, a learning module-operator 240, and a learning module-file writer 250.

In addition, the prediction module 300 may include a prediction module-file reader 310, a prediction module-runner 320, a prediction module-controller 330, a prediction module-operator 340, and a prediction module-file writer 150.

Accordingly, the system according to one aspect of the present disclosure may process work process monitoring-related data incoming in real time by: first using the preprocessing module 100 to perform a preprocessing work on monitoring-related real-time data for a work process of an actual manufacturing site, and store the data in the database server DB; using the learning module 200 to read the data stored in the database server DB by the preprocessing module 100 to perform a learning work, and store the data in the database server DB; and using the prediction module 300 to read the data stored in the database server DB by the learning module 200 to perform a prediction work, and store the data in the database server DB.

The preprocessing module 100 may include a preprocessing module-file reader 110, a preprocessing module-runner 120, a preprocessing module-controller 130, a preprocessing module-operator 140, and a preprocessing module-file writer 150.

The preprocessing module-file reader 110 may serve to read the monitoring-related real-time data for the work process of the actual manufacturing site.

The preprocessing module-runner 120 may serve to execute the preprocessing module-controller 130, the preprocessing module-operator 140, and the preprocessing module-file writer 150. In this case, the preprocessing module-runner 120 may determine a role of the preprocessing module 100. In other words, the preprocessing module 100 may be defined as a module for performing a preprocessing role through a function of the preprocessing module-runner 120.

The preprocessing module-controller 130 may serve to perform data flow planning and control of the preprocessing module 100. In this case, the preprocessing module-controller 130 may perform data flow planning and control for the preprocessing module-operator 140 and the preprocessing module-file writer 150, which are subsequent processes, according to characteristics of the preprocessing module 100.

The preprocessing module-operator 140 may be a fundamental configuration that serves to perform data processing in the preprocessing module 100. To this end, the preprocessing module-operator 140 may include a preprocessing module-preprocessing operator 141 as a detailed configuration.

The preprocessing module-preprocessing operator 141 may serve to perform preprocessing of the data. In this case, the preprocessing of the data performed by the preprocessing module-preprocessing operator 141 may be preprocessing of various known schemes.

The preprocessing module-file writer 150 may perform a write function of storing the data processed and modified through the preprocessing module-operator 140 in the database server DB.

The learning module 200 may include a learning module-file reader 210, a learning module-runner 220, a learning module-controller 230, a learning module-operator 240, and a learning module-file writer 250.

The learning module-file reader 210 may serve to load the data stored in the database server DB by the preprocessing module 100 to perform a read function.

The learning module-runner 220 may serve to execute the learning module-controller 230, the learning module-operator 240, and the learning module-file writer 250. In this case, the learning module-runner 220 may determine a role of the learning module 200. In other words, the learning module 200 may be defined as a module for performing a learning role through a function of the learning module-runner 220.

The learning module-controller 230 may serve to perform data flow planning and control of the learning module 200. In this case, the learning module-controller 230 may perform data flow planning and control for the learning module-operator 240 and the learning module-file writer 250, which are subsequent processes, according to characteristics of the learning module 200.

The learning module-operator 240 may be a fundamental configuration that serves to perform data processing in the learning module 200. To this end, the learning module-operator 240 may include a learning module-FDC length equalization operator 241, a learning module-FDC feature engineering operator 242, and a learning module-training operator 243 as detailed configurations. The learning module-operator 240 may generate learning model data through the learning module-FDC length equalization operator 241, the learning module-FDC feature engineering operator 242, and the learning module-training operator 243.

Since data lengths of wafers may be different from each other, the learning module-FDC length equalization operator 241 may adjust a data length for each wafer by using a length equalization function.

The learning module-FDC feature engineering operator 242 may perform a sensor data normalization function for the data having a length that is adjusted through the learning module-FDC length equalization operator 241.

The learning module-training operator 243 may serve to learn the data processed through the learning module-FDC length equalization operator 241 and the learning module-FDC feature engineering operator 242 by loading a known learning model such as SmartFDC, T2_SPE, or FDC_KNN, and may generate the learning model data.

The learning module-file writer 250 may perform a writing function of storing the learning model data generated through the learning module-operator 240 in the database server DB.

The prediction module 300 may include a prediction module-file reader 310, a prediction module-runner 320, a prediction module-controller 330, a prediction module-operator 340, and a prediction module-file writer 350.

The prediction module-file reader 310 may serve to load the data stored in the database server DB by the learning module 200 to perform a read function.

The prediction module-runner 320 may serve to execute the prediction module-controller 330, the prediction module-operator 340, and the prediction module-file writer 350. In this case, the prediction module-runner 320 may determine a role of the prediction module 300. In other words, the prediction module 300 may be defined as a module for serving to perform prediction and diagnosis through a function of the prediction module-runner 320.

The prediction module-controller 330 may serve to perform data flow planning and control of the prediction module 300. In this case, the prediction module-controller 330 may perform data flow planning and control for the prediction module-operator 340 and the prediction module-file writer 350, which are subsequent processes, according to characteristics of the prediction module 300.

The prediction module-operator 340 may be a fundamental configuration that serves to perform data processing in the prediction module 300. To this end, the prediction module-operator 340 may include a prediction module-prediction operator 341 and a prediction module-evaluation operator 342 as detailed configurations. The prediction module-operator 340 may generate prediction model data through the prediction module-prediction operator 341 and the prediction module-evaluation operator 342.

The prediction module-prediction operator 341 may input the data read through the prediction module-file reader 310 by loading the known learning model such as SmartFDC, T2_SPE, or FDC_KNN, and perform prediction on the data to generate prediction data. In this case, the prediction of the data may be performed by using the known learning model such as SmartFDC, T2_SPE, or FDC_KNN.

The prediction module-evaluation operator 342 may evaluate the prediction data generated through the prediction module-prediction operator 341. In this case, accuracy_score or f1score may be used to evaluate the prediction data.

The prediction module-file writer 350 may perform a write function of storing the data processed and modified through the prediction module-operator 340 in the database server DB.

Hereinafter, a method of processing an FDC system with a workflow connected by modularizing an entire process according to one aspect of the present disclosure will be described.

According to one aspect of the present disclosure, a method of processing an FDC system with a workflow connected by modularizing an entire process may include: a preprocessing module driving step S10 of performing preprocessing on data incoming in real time by using a preprocessing module 100; a learning module driving step S20 of generating a learning model by performing learning on the data, which has been subject to the preprocessing in the preprocessing module driving step S10, by using a learning module; and a prediction module driving step S30 of performing prediction by using a prediction module based on the learning model in the learning module driving step S20.

The preprocessing module driving step S10 may include a preprocessing module-file reading step S11, a preprocessing module-planning step S12, a preprocessing module-preprocessing step S13, a preprocessing module-file writing step S14.

In the preprocessing module-file reading step S11, the data incoming in real time may be read by using a preprocessing module-file reader 110. In this case, the data incoming in real-time in the preprocessing module-file reading step S11 may be monitoring-related real-time data for a work process of an actual manufacturing site.

In the preprocessing module-planning step S12, a data flow plan and a control plan of the preprocessing module 100 may be generated by using a preprocessing module-runner 120 and a preprocessing module-controller 130.

In the preprocessing module-preprocessing step S13, a preprocessing work may be performed on the data read in the preprocessing module-file reading step S11 by using a preprocessing module-preprocessing operator 141.

In the preprocessing module-file writing step S14, a data processing result for the data preprocessed in the preprocessing module-preprocessing step S13 may be written by using a preprocessing module-file writer 150, and stored in a database server DB.

The learning module driving step S20 may include a learning module-file reading step S21, a learning module-planning step S22, a learning module-data length equalization step S23, a learning module-data normalization step S24, a learning module-training step S25, and a learning module-file writing step S26.

In the learning module-file reading step S21, the data incoming in real time may be read by using a learning module-file reader 210. In this case, the data incoming in real time in the learning module-file reading step S21 may be the data that has been preprocessed in the preprocessing module driving step S10.

In the learning module-planning step S22, a data flow plan and a control plan of the learning module 200 may be generated by using a learning module-runner 220 and a learning module-controller 230.

In the learning module-data length equalization step S23, an operation of adjusting a length of the data read in the learning module-file reading step S21 to a shortest length or a longest length may be performed by using a learning module-FDC length equalization operator 241.

In the learning module-data normalization step S24, an operation of normalizing the data, which has a data length that is adjusted in the learning module-data length equalization step S23, for each wafer so as to adjust a data length for each wafer to one line per one wafer may be performed by using a learning module-FDC feature engineering operator 242.

In the learning module-training step S25, the data processed through the learning module-data length equalization step S23 and the learning module-data normalization step S24, which has been subject to the preprocessing, may be learned by loading a learning model by using a learning module-training operator 243.

In the learning module-file writing step S26, a data processing result for the data learned in the learning module-training step S25 may be written by using a learning module-file writer 250, and stored in the database server DB.

The prediction module driving step S30 may include a prediction module-file reading step S31, a prediction module-planning step S32, a prediction module-prediction progress step S33, a prediction module-evaluation progress step S34, and a prediction module-file writing step S35.

In the prediction module-file reading step S31, the data incoming in real time may be read by using a prediction module-file reader 310. In this case, the data incoming in real time in the prediction module-file reading step S31 may be data that has been processed in the learning module driving step S20.

In the prediction module-planning step S32, a data flow plan and a control plan of the prediction module 300 may be generated by using a prediction module-runner 320 and a prediction module-controller 330.

In the prediction module-prediction progress step S33, the data read in the prediction module-file reading step S31 may be input by loading a learning model and predicted to generate prediction data by using a prediction module-prediction operator 341.

In the prediction module-evaluation progress step S34, the prediction data generated in the prediction module-prediction progress step S33 may be evaluated by using a prediction module-evaluation operator 342.

In the prediction module-file writing step S35, a data processing result for the data that has been evaluated in the prediction module-evaluation progress step S34 may be written by a prediction module-file writer 350, and stored in the database server DB.

Through a configuration and a series of processes described above, according to one aspect of the present disclosure, an FDC system with a workflow connected by modularizing an entire process and a processing method thereof, in which processes such as preprocessing, learning, and prediction may be modularized so as to be managed, and modules may be connected to each other to generate the workflow so that application to different projects may be facilitated, and the entire process may be managed more systematically, have been developed.

Although the present disclosure has been described with the accompanying drawings, the description corresponds to only one embodiment among various embodiments including the gist of the present disclosure, and an object of the description is to enable those of ordinary skill in the art to easily implement the present disclosure, so that the present disclosure is not limited to the above-described embodiment. Therefore, the scope of the present disclosure is to be interpreted by the appended claims, and the scope of the present disclosure encompasses all technical ideas within the equivalent scope by changes, substitutions, alternatives, or the like without departing from the gist of the present disclosure. In addition, it is to be clarified that some components in the drawings are exaggerated or reduced than in reality to more clearly describe the components.

What is claimed is:

1. An FDC system with a workflow connected by modularizing an entire process, wherein the FDC system includes the workflow in which a preprocessing module, a learning module, and a prediction module are connected to each other.

2. The FDC system of claim 1, wherein the learning module includes a learning module-file reader, a learning module-runner, a learning module-controller, a learning module-operator, and a learning module-file writer, and
the prediction module includes a prediction module-file reader, a prediction module-runner, a prediction module-controller, a prediction module-operator, and a prediction module-file writer.

3. A method of processing an FDC system with a workflow connected by modularizing an entire process, the method comprising:
a preprocessing module driving step (S10) of performing preprocessing on data incoming in real time by using a preprocessing module;
a learning module driving step (S20) of generating a learning model by performing learning on the data, which has been subject to the preprocessing in the preprocessing module driving step (S10), by using a learning module; and
a prediction module driving step (S30) of performing prediction by using a prediction module based on the learning model in the learning module driving step (S20).

4. The method of claim 3, wherein the learning module driving step (S20) includes a learning module-file reading step (S21), a learning module-planning step (S22), a learning module-data length equalization step (S23), a learning module-data normalization step (S24), a learning module-training step (S25), and a learning module-file writing step (S26).

5. The method of claim 3, wherein the prediction module driving step (S30) includes a prediction module-file reading step (S31), a prediction module-planning step (S32), a prediction module-prediction progress step (S33), a prediction module-evaluation progress step (S34), and a prediction module-file writing step (S35).
